(19) United States
(12) Patent Application Publication
(10) Pub. No.: US 2020/0268165 A1
(43) Pub. Date: Aug. 27, 2020

(54) Medical Positioning Devices

(71) Applicant: LDI Corporation, Portsmouth, NH (US)

(72) Inventor: Louis J. LaMarca, II, Hampton Falls, NH (US)

(21) Appl. No.: 16/802,884

(22) Filed: Feb. 27, 2020

Related U.S. Application Data
(60) Provisional application No. 62/811,044, filed on Feb. 27, 2019.

(51) Int. Cl. A47C 27/14; C08L 23/04

(52) U.S. Cl. CPC A47C 27/14; C08L 23/04

(57) ABSTRACT

A cushioning product and corresponding method of use that employs closed cell foam which is configured to make medical patients relatively more comfortable and to provide relatively more support during a given medical procedure.

### CROSS-REFERENCE TO RELATED APPLICATIONS

This application claims the benefit of U.S. provisional patent application serial no. 62/811,044, filed Feb. 27, 2019, the entire disclosure of which is incorporated herein by reference.

### FIELD

The present invention is directed at a cushioning product which is configured to make medical patients relatively more comfortable and to provide relatively more support during a given medical procedure.

### BACKGROUND

Healthcare markets use a variety of relatively soft cushion items to make patients more comfortable and to support them during procedures. The current demand is supplied mainly by three product types which are discussed below.

First, there are reports regarding the use of open cell polyurethane foam. Some of the disadvantages of such foam is that it is not impervious and absorbs bodily fluids. In addition, it is not reusable and must be disposed of or incinerated as hazardous waste after use. In addition, it typically has relatively port tear strength and is susceptible to staining. Moreover, it is sourced from ingredients such as isocyanates, which are relatively toxic. On the mechanical property side, it often indicates relatively poor resiliency and a compression set, such that it will bottom out in use and will not recover, thereby not providing a comfortable support for a given patient.

Another reported option includes open cell polyurethane foam that has been dipped in a poly(vinyl chloride) plastisol. Some problems identified with this alternative include relative easy to puncture the surface which then makes the foam susceptible to body fluid absorption. Once the thin skin is compromised, such foam is again not reusable and must be disposed of or incinerated as hazardous waste. It also tears relatively easily and stains relatively easily and as noted above, relies upon the use of isocyanates for foam preparation, which are toxic. In addition, it again indicates relatively poor resiliency and compression set and the associated problem of bottoming out and not recovering, thereby again provide a foam that is not generally comfortable and supporting to a patient. Finally, since it relies upon a PVC based coating, it is worth noting that PVC itself is prone to formation of residual products when overheated or incinerated such as hydrochloric acid, chlorobenzene and dioxins which therefore defines an environmental problem when disposed. The PVC based coating also typically contains toxic additives, such as phthalate plasticizers, heavy metal stabilizers, biocides and halogen flame retardants. In addition, PVC coated foams may not effectively decompose in the ground and again, potentially introduce toxic components into ground water and local landfills.

Another reported option is identified as a PVC coated blue gel product. As expect, once cut or punctured, the gel can leak and the product is rendered unusable. Similar to the above, overheating or disposal by incineration will release toxic chemicals as a hazardous emission. Also, when placed in landfills, hazardous ingredients may leach out and degradation products may again be identified. Finally, it is worth nothing that such gel products are relatively heavy and very expensive.

### DETAILED DESCRIPTION OF PREFERRED EMBODIMENTS

The present invention is directed at a closed cell olefin foam, which is reference to a foam structure that relies upon a repeating unit of ethylene and/or propylene monomers that have been polymerized, as well as blends thereof. Accordingly, by way of example, the closed cell foam herein can preferably be made from ethylene, propylene and optionally a diene monomer component, as in EPDM type foam. Reference herein to closed cell foam is reference to a cellular structure wherein 90% or more of the cells are closed cells, more preferably 95% or more, or in the range of 90% to 100%. The closed cell olefin foam may also preferably rely upon poly(ethylene-vinylacetate) foam.

Preferably, such closed cell foam is one that indicates a Shore 00 Durometer in the range of 10-70, more preferably 10-50 or 10-30 or 15-25. The foam preferably has a density that falls in the range of 1-10 pound per cubic foot (pcf), more preferably in the range of 1-6 pcf or 1-3 pcf. Shore 00 Durometer herein is measured according to ASTM D2240. The foams preferably have a water absorption by weight of less than or equal to 7.0%, or in the range of 0.1% to 7.0% by weight. Preferably, the foams can have a water absorption of 0.1% to 5.0%, or even more preferably, 0.1% to 3.0%. Tensile strength preferably ranges from 20 psi to 300 psi. Elongation preferably ranges from 25% to 350%. The foams are observed to compress with the weight of a typical person's head (4.5 kg to 5.0 kg) and recover. More specifically, the foams may have a compression strength (25% deflection) pursuant to ASTM D 3575 in the range of 5-10 psi.

A preferred foam herein of poly(ethylene-vinyl acetate) is available from Sekisui under the name MINICEL® Type T at a density of 2.0 pcf or 6.0 pcf. The properties of such preferred foam are listed below:

| | 2pcf | 6pcf |
|---|---|---|
| Compression Strength/(ASTM D3575) | | |
| (lb/sq-in) @ 25% compression | 4 | 16 |
| (lb/sq-in) @ 50% compression | 11 | N/A |
| Tensile Strength/(ASTM D3575) | | |
| (lb/sq-in) Machine Direction | 62 | 186 |
| Tensile Elongation/(ASTM D3575) | | |
| (%) Machine Direction | 337 | 347 |
| Tear Resistance/(ASTM D3575) | | |
| (lb/in) Machine Direction | 9 | 24 |
| Compression Set/(ASTM D3575) | | |
| % Original Thickness | 16 | 4 |
| Thermal Stability 24 Hour Test @ 176° F. (70° C.) | | |
| AVE MD % | −3.6 | −1.7 |

The foams are also stain resistant (being impervious to fluids) and the polyolefin composition provides a foam material that is environmentally friendlier as it will not, e.g., incinerate into toxic by-products such as hydrochloric acid. The foams may therefore be reused and can be reused over 20 times. Accordingly, the foams herein may be reused up to 40-50 times. In addition, given the properties of the foam herein, the foam is not one that must be disposed of as a hazardous waste material.

Furthermore, the foams herein are such that they are preferably free of chlorine, phthalates and/or antimony based additives. In addition, the foams herein can be free of biocides, heavy metals and/or halogen based flame retardants. Accordingly, with respect to any one of chlorine, phthalates, antimony based additives, biocides, heavy metals, or halogen based flame retardants, the foams here are such that they preferably free of such components, or that the concentration of any one of these components is such that it is present at a level of less than or equal to 1.0% by weight.

Particular preferred foams for use as a medical position device herein therefore include EPDM foam and EPDM foam that is blended with neoprene (polychloroprene) and styrene-butadiene rubber. Another preferred blend that can be used for the foam comprises poly(ethylene-vinyl acetate) that may be blended with a polyethylene. Such blends may be configured to preferably have the properties and characteristics noted above. Another blend herein includes a blend of neoprene, EPDM and SBR sold as “4311-N” by Jacobs and Thompson.

Accordingly, the present disclosure identifies a medical positioning device sourced from closed cell foam that among other things, provides a relatively clean and reusable foam support for a medical patient, that is impervious to fluids, provides desirable mechanical properties and a more environmentally friendlier material for ultimate disposal requirements.

1. A method of cushioning a patient for medical care comprising:
supplying a closed cell olefin foam wherein 90% or more of the cells are closed cells and said foam has a Shore 00 Durometer in the range of 10-70 and a density in the range of 1-10 pounds per cubic foot;
cushioning said patient with said closed cell olefin foam.

2. The method of claim 1 wherein 95% or more of the cells are closed cells.

3. The method of claim 1 wherein said foam indicates a Shore 00 Durometer in the range of 10-50.

4. The method of claim 1 wherein said foam indicates a Shore 00 Durometer in the range of 10-30.

5. The method of claim 1 wherein said foam indicates a Shore 00 Durometer in the range of 15-25.

6. The method of claim 1 wherein said foam has a water absorption by weight of less than or equal to 7.0%.

7. The method of claim 1 wherein said foam has a tensile strength of 20 psi to 300 psi.

8. The method of claim 1 wherein said foam has an elongation of 25% to 350%.

9. The method of claim 1 wherein said foam comprises poly(ethylene-vinyl acetate).

10. The method of claim 1 wherein said foam is free of chlorine, phthalates and/or antimony based additives.

11. The method of claim 1 wherein said foam is free of biocides, heavy metals, and/or halogen based flame retardants.

12. A foam for use as a medical cushioning product where said foam comprises a closed cell olefin foam wherein 90% or more of the cells are closed cells and said foam has a Shore 00 Durometer in the range of 10-70 and a density in the range of 1-10 pounds per cubic foot.
